(19) United States
(12) Patent Application Publication
(10) Pub. No.: US 2025/0056584 A1
(43) Pub. Date: Feb. 13, 2025

(54) MULTI-CARRIER SCHEDULING FOR SIDELINK COMMUNICATIONS

(71) Applicant: QUALCOMM Incorporated, San Diego, CA (US)

(72) Inventors: Hui GUO, Beijing (CN); Shuanshuan WU, San Diego, CA (US); Kapil GULATI, Belle Mead, NJ (US); Tien Viet NGUYEN, Bridgewater, NJ (US); Anantharaman BALASUBRAMANIAN, San Diego, CA (US)

(21) Appl. No.: 18/718,744

(22) PCT Filed: Feb. 3, 2022
(86) PCT No.: PCT/CN2022/075314

§ 371 Date: Jun. 11, 2024

(51) Int. Cl. H04W 72/40; H04L 1/1812; H04L 5/00; H04W 28/26; H04W 72/25

(52) U.S. Cl. CPC H04W 72/40; H04L 1/1812; H04L 5/001; H04W 28/26; H04W 72/25

(57) ABSTRACT

Various aspects of the present invention generally disclose wireless communication. In some aspects, a user equipment (UE) may receive a configuration of a first resource pool associated with a first component carrier and a second resource pool associated with a second component carrier. The UE may transmit an indication of a resource reservation associated with a sidelink communication, wherein the resource reservation indicates a first set of resources associated with the first resource pool and a second set of resources associated with the second resource pool, and wherein the indication of the resource reservation is transmitted in at least one of a first control channel associated with the first component carrier or a second control channel associated with the second component carrier.

### FIELD OF THE DISCLOSURE

Aspects of the present disclosure generally relate to wireless communication and to techniques and apparatuses for multi-carrier scheduling for sidelink communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications and access link communications, in accordance with the present disclosure.

FIG. 4 is a diagram illustrating an example of sidelink communications, in accordance with the present disclosure.

FIG. 5 is a diagram illustrating examples of carrier aggregation, in accordance with the present disclosure.

FIG. 6 is a diagram illustrating an example associated with multi-carrier scheduling for sidelink communications, in accordance with the present disclosure.

FIGS. 7A and 7B are diagrams illustrating examples associated with multi-carrier scheduling for sidelink communications, in accordance with the present disclosure.

FIG. 8 is a diagram illustrating an example process performed, for example, by a UE, in accordance with the present disclosure.

FIG. 9 is a diagram of an example apparatus for wireless communication, in accordance with the present disclosure.

### SUMMARY

Some aspects described herein relate to a method of wireless communication performed by a user equipment (UE). The method may include receiving a configuration of a first resource pool associated with a first component carrier and a second resource pool associated with a second component carrier. The method may include transmitting an indication of a resource reservation associated with a sidelink communication, wherein the resource reservation indicates a first set of resources associated with the first resource pool and a second set of resources associated with the second resource pool, and wherein the indication of the resource reservation is transmitted in at least one of a first control channel associated with the first component carrier or a second control channel associated with the second component carrier. The method may include performing the sidelink communication in accordance with the resource reservation.

Some aspects described herein relate to an apparatus for wireless communication at a UE. The UE may include a memory and one or more processors coupled to the memory. The one or more processors may be configured to receive a configuration of a first resource pool associated with a first component carrier and a second resource pool associated with a second component carrier. The one or more processors may be configured to transmit an indication of a resource reservation associated with a sidelink communication, wherein the resource reservation indicates a first set of resources associated with the first resource pool and a second set of resources associated with the second resource pool, and wherein the indication of the resource reservation is transmitted in at least one of a first control channel associated with the first component carrier or a second control channel associated with the second component carrier. The one or more processors may be configured to perform the sidelink communication in accordance with the resource reservation.

Some aspects described herein relate to a non-transitory computer-readable medium that stores a set of instructions for wireless communication by a UE. The set of instructions, when executed by one or more processors of the UE, may cause the UE to receive a configuration of a first resource pool associated with a first component carrier and a second resource pool associated with a second component carrier. The set of instructions, when executed by one or more processors of the UE, may cause the UE to transmit an indication of a resource reservation associated with a sidelink communication, wherein the resource reservation indicates a first set of resources associated with the first resource pool and a second set of resources associated with the second resource pool, and wherein the indication of the resource reservation is transmitted in at least one of a first control channel associated with the first component carrier or a second control channel associated with the second component carrier. The set of instructions, when executed by one or more processors of the UE, may cause the UE to perform the sidelink communication in accordance with the resource reservation.

Some aspects described herein relate to an apparatus for wireless communication. The apparatus may include means for receiving a configuration of a first resource pool associated with a first component carrier and a second resource pool associated with a second component carrier. The apparatus may include means for transmitting an indication of a resource reservation associated with a sidelink communication, wherein the resource reservation indicates a first set of resources associated with the first resource pool and a second set of resources associated with the second resource pool, and wherein the indication of the resource reservation is transmitted in at least one of a first control channel associated with the first component carrier or a second control channel associated with the second component carrier. The apparatus may include means for performing the sidelink communication in accordance with the resource reservation.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

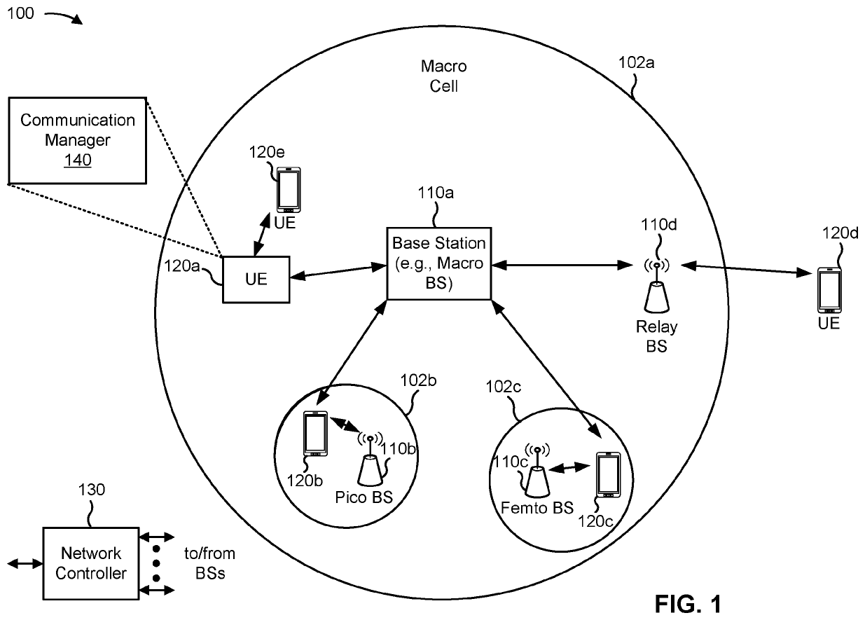

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz 300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a configuration of a first resource pool associated with a first component carrier and a second resource pool associated with a second component carrier; transmit an indication of a resource reservation associated with a sidelink communication, wherein the resource reservation indicates a first set of resources associated with the first resource pool and a second set of resources associated with the second resource pool, and wherein the indication of the resource reservation is transmitted in at least one of a first control channel associated with the first component carrier or a second control channel associated with the second component carrier; and perform the sidelink communication in accordance with the resource reservation. Additionally, or alternatively, the communication manager 140 may perform one or more other operations described herein.

As indicated above, FIG. 1 is provided as an example. Other examples may differ from what is described with regard to FIG. 1.

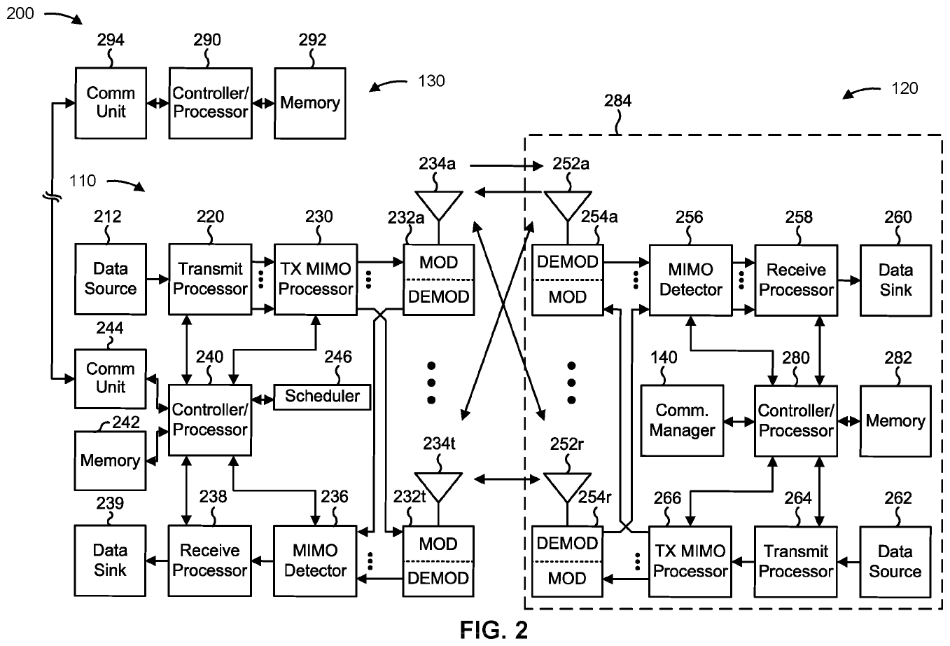

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

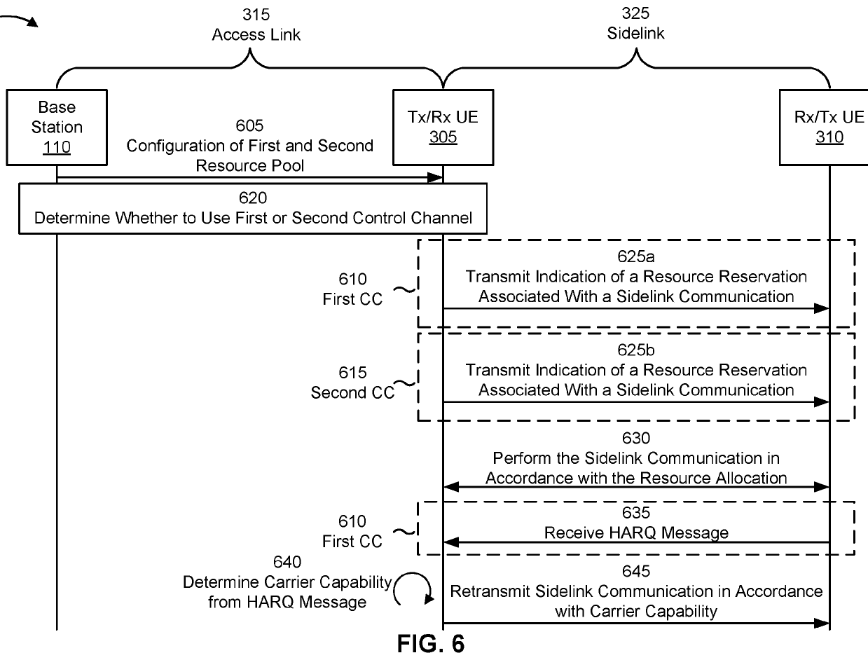

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-9).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-9).

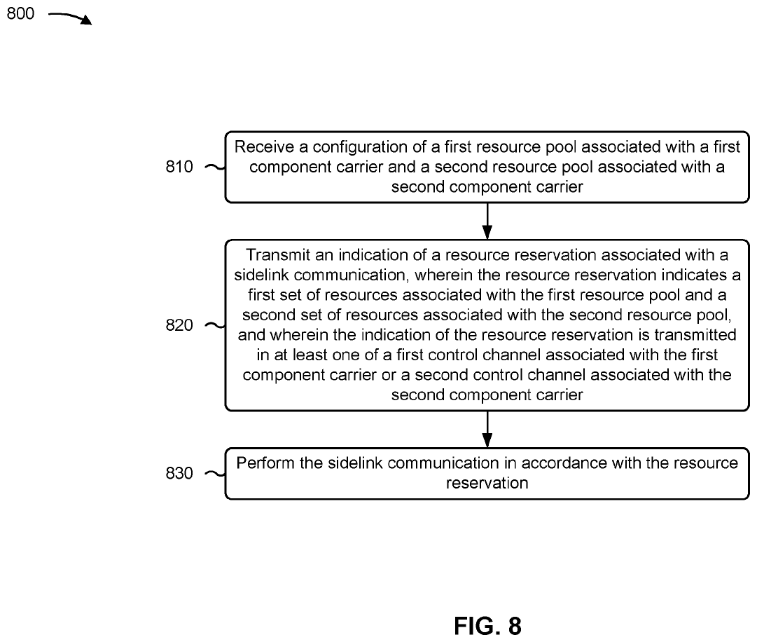

The controller/processor 240 of the base station 110, the controller/processor 280 of the UE 120, and/or any other component(s) of FIG. 2 may perform one or more techniques associated with for multi-carrier scheduling for sidelink communications, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for receiving a configuration of a first resource pool associated with a first component carrier and a second resource pool associated with a second component carrier; means for transmitting an indication of a resource reservation associated with a sidelink communication, wherein the resource reservation indicates a first set of resources associated with the first resource pool and a second set of resources associated with the second resource pool, and wherein the indication of the resource reservation is transmitted in at least one of a first control channel associated with the first component carrier or a second control channel associated with the second component carrier; and/or means for performing the sidelink communication in accordance with the resource reservation. The means for the user UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

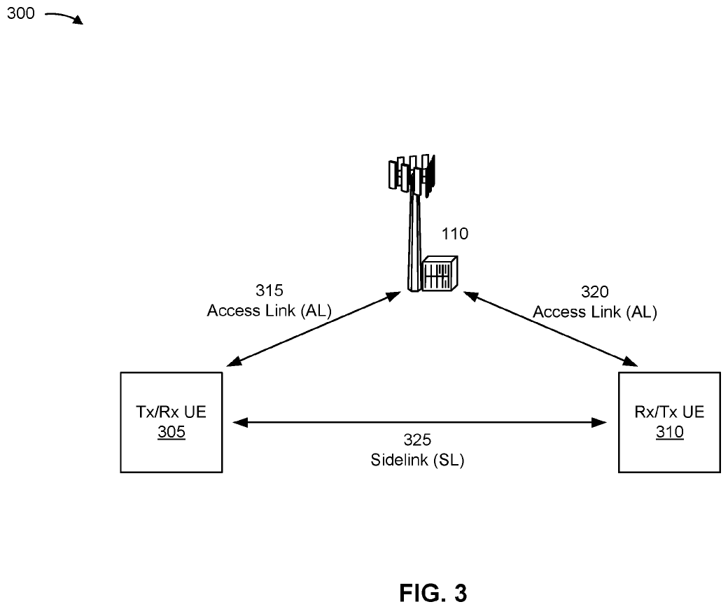

FIG. 3 is a diagram illustrating an example 300 of sidelink communications and access link communications, in accordance with the present disclosure.

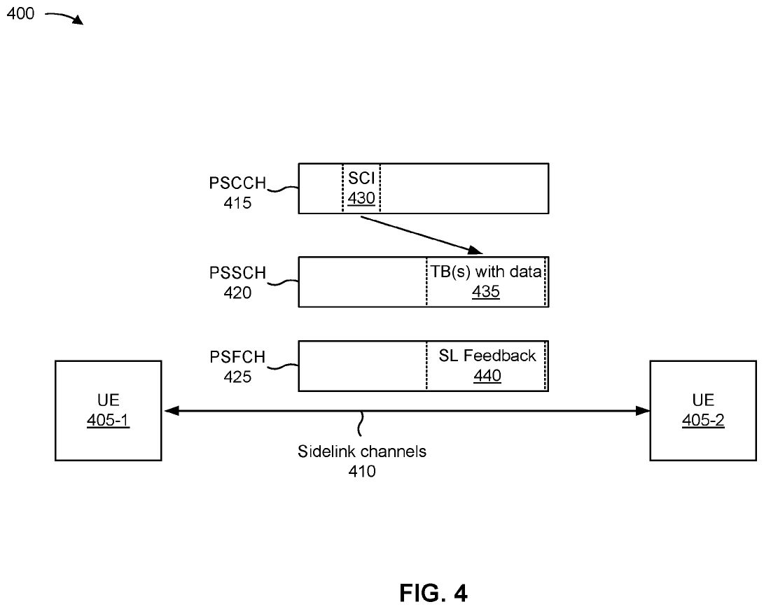

As shown in FIG. 3, a transmitter (Tx)/receiver (Rx) UE 305 and an Rx/Tx UE 310 may communicate with one another via a sidelink. In some sidelink modes, a base station 110 may communicate with the Tx/Rx UE 305 via a first access link 315. Additionally, or alternatively, in some sidelink modes, the base station 110 may communicate with the Rx/Tx UE 310 via a second access link 320. The Tx/Rx UE 305 and/or the Rx/Tx UE 310 may correspond to one or more UEs described elsewhere herein, such as the UE 120 of FIG. 1. Thus, a direct link between UEs 120 (e.g., via a PC5 interface) may be referred to as a sidelink 325, and a direct link between a base station 110 and a UE 120 (e.g., via a Uu interface) may be referred to as an access link 315, 320. Sidelink communications may be transmitted via the sidelink 325, and access link communications may be transmitted via the access link 315, 320. An access link communication may be either a downlink communication (from a base station 110 to a UE 120) or an uplink communication (from a UE 120 to a base station 110). Aspects of the sidelink 325 are described in more detail below in connection with FIG. 4.

As indicated above, FIG. 3 is provided as an example. Other examples may differ from what is described with respect to FIG. 3.

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. In some aspects, the UEs 405 (e.g., the first UE 405-1 and/or the second UE 405-2) may correspond to one or more other UEs described elsewhere herein, such as UE 120. Additionally, or alternatively, the first UE 405-1 may correspond to one of the Tx/Rx UE 305 or the Rx/Tx UE 310, and the second UE 405-2 may correspond to the other of the Tx/Rx UE 305 or the Rx/Tx UE 310. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a base station 110 via an access link or an access channel (e.g., via the access link 315 and/or the access link 320). The PSSCH 420 may be used to communicate data, similar to a physical downlink shared channel (PDSCH) and/or a physical uplink shared channel (PUSCH) used for cellular communications with a base station 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information), transmit power control (TPC), and/or a scheduling request (SR). For example, when a transmitter UE is operating in a groupcast mode 1 (e.g., connectionless-based groupcast operation) or a broadcast mode, NACK-only information may be communicated using the PSFCH 425, and when a transmitter UE is operating in a groupcast mode 2 (e.g., connection-based groupcast operation) or unicast mode, ACK/NACK information may be communicated using the PSFCH 425.

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QOS) priority value, a resource reservation period, a PSSCH DMRS pattern, an SCI format for the SCI-2, a beta offset for the SCI-2, a quantity of PSSCH DMRS ports, and/or an MCS. Moreover, the SCI-1 may include a number of reserved bits as determined by a higher layer parameter (sometimes referred to as sl-NumReservedBits), with a value typically set to zero (e.g., a value of the sl-NumReservedBits is set to zero when no reserved bits are necessary for the SCI signaling). The SCI-2 may include information associated with data transmissions on the PSSCH 420, such as information for decoding the data transmissions, a HARQ process ID, a new data indicator (NDI), a source identifier, a destination identifier, and/or a channel state information (CSI) report trigger.

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1) where resource selection and/or scheduling is performed by a base station 110. For example, the UE 405 may receive a grant (e.g., in downlink control information (DCI) or in a radio resource control (RRC) message, such as for configured grants) from the base station 110 for sidelink channel access and/or scheduling. In some aspects, a UE 405 may operate using a transmission mode (e.g., Mode 2) where resource selection and/or scheduling is performed by the UE 405 (e.g., rather than a base station 110). In some aspects, the UE 405 may perform resource selection and/or scheduling by sensing channel availability for transmissions. For example, the UE 405 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy rate (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or an MCS to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

As indicated above, FIG. 4 is provided as an example. Other examples may differ from what is described with respect to FIG. 4.

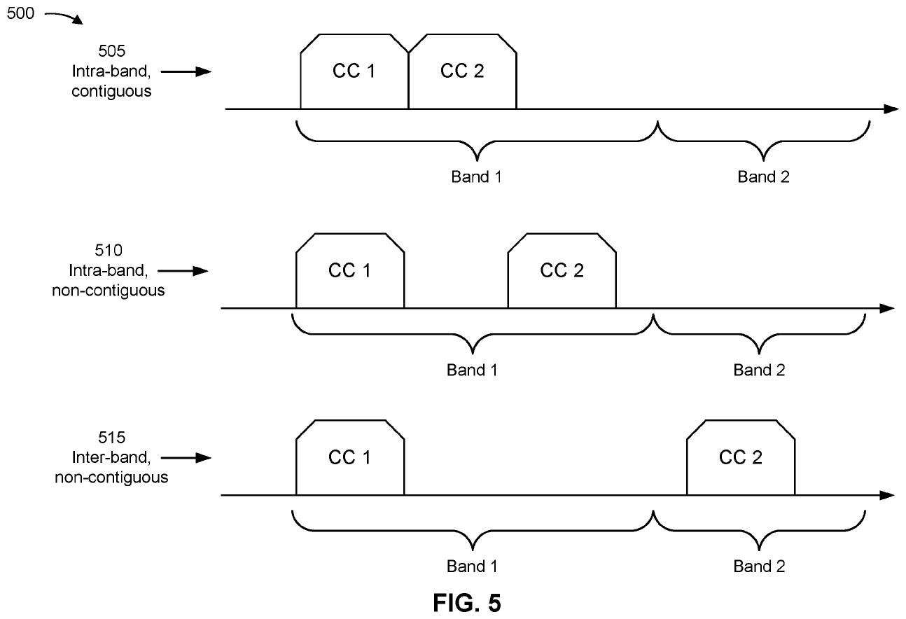

FIG. 5 is a diagram illustrating examples 500 of carrier aggregation, in accordance with the present disclosure.

In some aspects, it may be beneficial for UEs communicating using the sidelink 325 (e.g., one or more of UEs 120, 305, 310, 405-, 405-2, described above) to communicate using multiple carriers, such as by employing carrier aggregation or similar techniques. Carrier aggregation enables two or more component carriers (CCs, sometimes referred to as carriers) to be combined (e g, into a single channel) for a single UE 120 to enhance data capacity. As shown, carriers can be combined in the same or different frequency bands. Additionally, or alternatively, contiguous or non-contiguous carriers can be combined. A base station 110 may configure carrier aggregation for a UE 120, such as in an RRC message, DCI, and/or another signaling message.

As shown by reference number 505, in some aspects, carrier aggregation may be configured in an intra-band contiguous mode where the aggregated carriers are contiguous to one another and are in the same band. As shown by reference number 510, in some aspects, carrier aggregation may be configured in an intra-band non-contiguous mode where the aggregated carriers are non-contiguous to one another and are in the same band. As shown by reference number 515, in some aspects, carrier aggregation may be configured in an inter-band non-contiguous mode where the aggregated carriers are non-contiguous to one another and are in different bands.

In carrier aggregation, a UE 120 may be configured with a primary carrier or primary cell (PCell) and one or more secondary carriers or secondary cells (SCells). In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling. In some aspects, rather than combining the two component carriers into a single channel, a transmission may be selectively scheduled on one or both of the component carriers based at least in part on UE 120 and/or base station 110 capability, network traffic, or the like.

It may be beneficial for UEs (e.g., UEs 120, 305, 310, 405-1, 405-2) to utilize carrier aggregation and/or multiple-carrier techniques for sidelink communication to support advanced applications requiring high throughput, such as coordinated driving, sensor sharing with V2V and V2I, links to achieve autonomous driving, and the like. However, traditional sidelink control channels (e.g., PSCCH 415) and feedback channels (e.g., PSFCH 425) were designed for scheduling communications and providing feedback only in a single carrier. For example, traditionally an SCI-1 transmitted in a legacy carrier (e.g., in a PSCCH 415 associated with the legacy carrier) carries information associated with resource allocation or the like for data transmissions occurring only in the legacy carrier (e.g., the SCI-1 includes information associated only with data transmissions occurring in the PSSCH 420 associated with the legacy carrier). Similarly, sidelink feedback 440 provided in a feedback channel of the legacy carrier (e.g., in a PSFCH 425 associated with the legacy carrier) carries information associated only with retransmissions within the legacy carrier (e.g., a NACK transmission in a PSFCH 425 associated with the legacy carrier carries information only applicable to retransmissions within the legacy carrier). As a result, communication in the sidelink 325 may be limited to legacy carriers or the like, resulting in congested channels, reduced throughput, increased latency, and otherwise unreliable communication channels for advanced sidelink applications.

Some techniques and apparatuses described herein enable multi-carrier and/or cross-carrier resource scheduling for sidelink communications, as well as multi-carrier and/or cross-carrier feedback signaling for sidelink communications. In some aspects, data transmissions on each of multiple component carriers are scheduled using a respective SCI-1 and/or a PSCCH channel associated with each of multiple component carriers. In some other aspects, data transmissions on each of multiple component carriers are scheduled using an SCI-1 and/or a PSCCH channel associated with one of the multiple component carriers. In such aspects, a set of reserved bits in the SCI-1 and/or a set of bits associated with a carrier indication field of the SCI-1 may be used to indicate resource allocation for a specific carrier of the multiple component carriers. A determination of which PSCCH to utilize for scheduling resources in one or more carriers may be based at least in part on factors such a receiver UE's carrier capability, one or more interference or channel congestion measurements, available bandwidth on each carrier, a cast type of the data transmission, or the like. In some aspects, a network may signal to a transmitter UE which PSCCH to utilize for scheduling resources in one or more carriers. Additionally, or alternatively, a format of a sidelink feedback transmission, such as a HARQ message, may indicate which ones of the multiple component carriers may be used for a retransmission. As a result, a UE may indicate resource reservations in various component carriers and/or retransmit communications in various component carriers, enabling UEs communicating in the sidelink to employ carrier aggregation and/or multi-carrier sidelink communication techniques, resulting in a broader spectrum usage, increased throughput, decreased latency, and more reliable communication channels for advanced sidelink applications.

As indicated above, FIG. 5 is provided as an example. Other examples may differ from what is described with regard to FIG. 5.

FIG. 6 is a diagram illustrating an example 600 associated with multi-carrier scheduling for sidelink communications, in accordance with the present disclosure. As shown in FIG. 6, a first UE 120 (e.g., the Tx/Rx UE 305 in the depicted example, but which, in some other aspects, may correspond to any of the other UEs described herein, such as one of the first UE 405-1 or the second UE 405-2) and a second UE 120 (e.g., the Rx/Tx UE 310 in the depicted example, but which, in some other aspects, may correspond to any of the other UEs described herein, such as one of the first UE 405-1 or the second UE 405-2) may communicate with one another via the sidelink 325. Moreover, one or both of the UEs 305, 310 may communicate with a base station 110 via a respective access link 315, 320. For example, for purposes of the description, the Tx/Rx UE 305 is shown in communication with the base station 110 via the access link 315, but, in some other aspects, the Rx/Tx UE 310 may instead be in communication with the base station 110 via the access link 320, and/or both the Tx/Rx UE 305 and the Rx/Tx UE 310 may be in communication with the base station 110 via the access links 315 and 320, respectively. Moreover, in some aspects, one or both of the UEs 305, 310 may be in communication with multiple other UEs, such as when one of the UEs 305, 310 is operating in a groupcast or a broadcast mode, as described in more detail below.

As shown by reference number 605, the Tx/Rx UE 305 may receive, from the base station 110, a configuration of a first resource pool associated with a first component carrier 610 and a second resource pool associated with a second component carrier 615. In some aspects, the first component carrier 610 may be a legacy carrier (e.g., a component carrier associated with a relatively old release of a wireless communication standard or the like), while the second component carrier 615 may be a non-legacy carrier (e.g., a component carrier associated with a relatively new release of the wireless communication standard or the like). At a high level, a resource pool is a set of resources available for sidelink communication. More particularly, a resource pool is a set of resources configured for (e.g., assigned for) sidelink communication. A resource pool may be configured via semi-static (e.g., RRC) signaling. A resource pool may be configured to include particular time resources (e.g., slots) and a particular set of contiguous frequency resources (e.g., resource blocks). A resource pool (e.g., the arrangement of time resources included in the resource pool) may periodically repeat. Accordingly, the configuration indicated by reference number 605 (which, in some aspects, may be received via RRC signaling) may include a configuration of a first set of time and/or frequency resources available for performing sidelink communication in the first component carrier 610 and a configuration of a second set of time and/or frequency resources available for performing sidelink communication in the second component carrier 615. In some aspects, the first component carrier 610 and the second component carrier 615 may be employed for purposes of carrier aggregation and/or multi-carrier resource scheduling as described above in connection with FIG. 5, and thus the first component carrier 610 and/or the second component carrier 615 may each correspond to one of the component carriers described above in connection with FIG. 5.

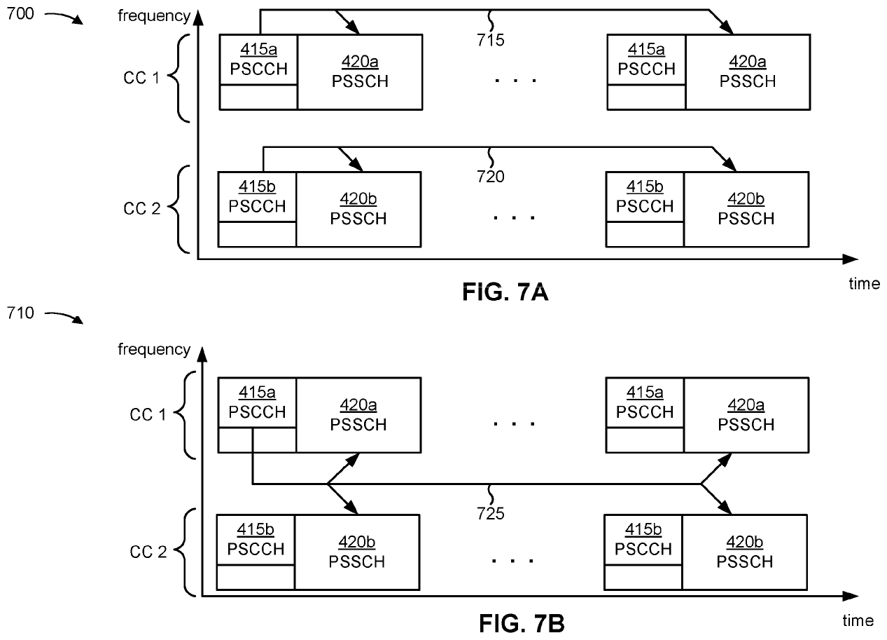

As shown by reference number 620, the base station 110 and/or the Tx/Rx UE 305 may determine whether to use a first control channel (e.g., a first PSCCH 415) associated with the first component carrier 610 and/or a second control channel (e.g., a second PSCCH 415) associated with the second component carrier 615 for transmitting one or more messages to the Rx/Tx UE 310 via the sidelink 325. More particularly, as described more fully below, the Tx/Rx UE 305 may transmit control information including an indication of a resource reservation to the Rx/Tx UE 310 using an SCI-1 communication provided in a PSCCH 415 or the like, and, at the determination indicated by reference number 620, the base station 110 and/or the Tx/Rx UE 305 may determine whether to use a PSCCH 415 associated with the first component carrier 610 for transmitting the control information, and/or whether to use a PSCCH 415 associated with the second component carrier 615 for transmitting the control information. In aspects in which the base station 110 determines whether to use the first control channel and/or the second control channel for transmitting the control information, the Tx/Rx UE 305 may receive, from the base station 110, an indication of whether to use the first control channel or the second control channel. Aspects of the determination indicated by reference number 620, including factors considered by the base station 110 and/or the Tx/Rx UE 305 when making the determination, are described more fully below in connection with FIGS. 7A and 7B, below.

As indicated by reference numbers 625a and 625b, the Tx/Rx UE 305 may transmit, to the Rx/Tx UE 310, an indication of a resource reservation associated with a sidelink communication. In some aspects, the indication of the resource reservation indicates a first set of resources associated with the first resource pool (e.g., associated with the first component carrier 610) and a second set of resources associated with the second resource pool (e.g., associated with the second component carrier 615). Moreover, in aspects in which it was determined, in the determination indicated by reference number 620, that the first control channel should be used, the indication of the resource reservation associated with the sidelink communication is transmitted in the first component carrier 610 (more particularly, using a first PSCCH 415 associated with the first component carrier 610), as indicated by reference number 625a. Similarly, in aspects in which it was determined, in the determination indicated by reference number 620, that the second control channel should be used, the indication of the resource reservation associated with the sidelink communication is transmitted in the second component carrier 615 (more particularly, using a second PSCCH 415 associated with the second component carrier 615), as indicated by reference number 625b. In aspects in which it was determined, in the determination indicated by reference number 620, that both the first control channel and the second control channel should be used, the indication of the resource reservation associated with the sidelink communication is transmitted in both the first component carrier 610 and the second component carrier 615 (more particularly, using both a first PSCCH 415 associated with the first component carrier 610, as indicated by reference number 625a, and a second PSCCH 415 associated with the second component carrier 615, as indicated by reference number 625b). Moreover, although in FIG. 6 the indication of the resource reservation associated with the sidelink communication is shown as being transmitted only to the Rx/Tx UE 310 for ease of the description, aspects of the disclosure are not so limited and, in some other aspects, the indication of the resource reservation associated with the sidelink communication may be transmitted to more than one UE, such as when the Tx/Rx UE 305 is operating in a groupcast mode, a broadcast mode, or a similar mode.

As shown by reference number 630, the Tx/Rx UE 305 and the Rx/Tx UE 310 may perform the sidelink communication in accordance with the resource reservation. More particularly, the Tx/Rx UE 305 and the Rx/Tx UE 310 may communicate using the resources indicated by the indication of the resource reservation. In some aspects, the Tx/Rx UE 305 may transmit a communication to the Rx/Tx UE 310 as indicated by reference number 630, and the Rx/Tx UE 310 may transmit a HARQ message associated with the communication, as indicated reference number 635. In some aspects, the HARQ message may be transmitted in the first component carrier 610, and, more particularly, within a PSFCH 425 of the first component carrier 610. Moreover, as shown by reference number 640, in some aspects, the Tx/Rx UE 305 may determine a carrier capability of the Rx/Tx UE 310 (e.g., whether the Rx/Tx UE 310 supports carrier aggregation and/or multi-carrier techniques or the like) based at least in part on a format of the HARQ message indicated at reference number 635.

As shown by reference number 645, the Tx/Rx UE 305 may retransmit the sidelink communication in accordance with the carrier capability of the Rx/Tx UE 310 (e.g., using one or both of the first component carrier 610 or the second component carrier 615, according to the capability of the Rx/Tx UE 310). For example, the format of the HARQ message shown at reference number 635 may indicate that the Rx/Tx UE 310 may receive sidelink communications using only the first component carrier 610. Accordingly, in the transmission shown at reference number 645, the sidelink communication may be retransmitted using the first component carrier 610. Similarly, the format of the HARQ message shown at reference number 635 may indicate that the other UE may receive sidelink communications using both the first component carrier 610 and the second component carrier 615. Accordingly, in the transmission shown at reference number 645, the sidelink communication may be retransmitted using one or both of the first component carrier 610 or the second component carrier 615. Aspects of the HARQ features are described more fully in connection with FIGS. 7A and 7B, below.

As indicated above, FIG. 6 is provided as an example. Other examples may differ from what is described with regard to FIG. 6.

FIGS. 7A and 7B are diagrams illustrating examples 700 and 710, respectively, associated with multi-carrier scheduling for sidelink communications, in accordance with the present disclosure.

In the examples 700, 710 shown in FIGS. 7A and 7B, sidelink communications are communicated using a first component carrier (shown as CC 1, which may correspond to the first component carrier 610 described in connection with FIG. 6 and/or one of the component carriers described in connection with FIG. 5) and in a second component carrier (shown as CC 2, which may correspond to the second component carrier 615 described in connection with FIG. 6 and/or one of the component carriers described in connection with FIG. 5). In the aspect depicted in FIG. 7A, a control channel (e.g., PSCCH 415) associated with each component carrier is used for indicating a resource reservation for the respective component carrier. For example, a PSCCH 415a associated with the first component carrier may be used to indicate a resource reservation in a PSSCH 420a associated with the first component carrier, and a PSCCH 415b associated with the second component carrier may be used to indicate a resource reservation in a PSSCH 420b associated with the second component carrier. More particularly, as indicated by arrow 715, the PSCCH 415a associated with the first component carrier (and, more particularly, an SCI-1 message sent in the PSCCH 415a) may be used to indicate a resource reservation in one or more instances of the PSSCH 420a associated with the first component carrier. Similarly, as indicated by arrow 720, the PSCCH 415b associated with the second component carrier (and, more particularly, an SCI-1 message sent in the PSCCH 415b) may indicate a resource reservation in one or more instances of the PSSCH 420b associated with the second component carrier.

In such aspects, the UEs receiving an indication of the reservation information (e.g., Rx/Tx UE 310) for a particular component carrier may receive the indication regardless of the UE's carrier capability. More particularly, if the Rx/Tx UE 310 is capable of receiving communications in the first component carrier but not the second component carrier, the Rx/Tx UE 310 will receive the control information for the first component carrier via the PSCCH 415a. Such aspects may be beneficial when a carrier capability of the Rx/Tx UE 310 is unknown. More particularly, at least one of the first component carrier and the second component carrier may be a legacy carrier, and by scheduling resources for each carrier using a respective PSCCH 415 associated with the carrier, the Rx/Tx UE 310 may receive control information even if the Rx/Tx UE 310 is capable of communicating only in the legacy carrier.

For the example 700 shown in FIG. 7A, a legacy format of an SCI-1 message may be used to indicate the resource reservation, because the SCI-1 message is used to indicate resource reservation information within the same component carrier in which the SCI-1 message is transmitted. However, in some other aspects, a different format than the legacy format of the SCI-1 may be used to indicate the resource reservation. For example, the SCI-1 message may include a carrier aggregation field, a carrier indication field, or the like, used to indicate a carrier to which the SCI-1 pertains. Thus, in the aspects depicted in FIG. 7A, the carrier aggregation field may include an indication that the resource reservation corresponds to the component carrier in which the SCI-1 was transmitted.

In the example 710 depicted in FIG. 7B, a control channel (e.g., PSCCH 415) in one component carrier carries control information (e.g., indicates a resource reservation) for both the first component carrier and the second component carrier. For example, the PSCCH 415a associated with the first component carrier may be used to indicate a resource reservation for both a PSSCH 420a associated with the first component carrier and for a PSSCH 420b associated with the second component carrier. More particularly, as indicated by arrow 725, the PSCCH 415a associated with the first component carrier may be used to indicate a resource reservation in one or more instances of the PSSCH 420a associated with the first component carrier as well as one or more instances of the PSSCH 420b associated with the second component carrier.

In such aspects, a carrier capability of the Rx/Tx UE 310 (e.g., the receiver UE) may be known to the Tx/Rx UE 305 (e.g., the transmitter UE) prior to the Tx/Rx UE 305 transmitting the control information in the PSCCH 415a to ensure that the Rx/Tx UE 310 receives the control information. In some aspects, the Tx/Rx UE 305 may request carrier capability information from the Rx/Tx UE 310 prior to transmitting the indication of the resource reservation. In some aspects, once received, the Tx/Rx UE 305 may transmit an indication of the carrier capability of the Rx/Tx UE 310 to the base station 110, and the base station 110 may determine which control channels to use to transmit the indication of the resource reservation (e.g., whether to use the PSCCH 415a associated with the first component carrier, whether to use the PSCCH 415b associated with the second component carrier, or whether to use both the PSCCH 415a associated with the first component carrier and the PSCCH 415b associated with the second component carrier), as described above in connection with reference number 620. In some other aspects, the Tx/Rx UE 305 itself may determine which control channels to use to transmit the indication of the resource reservation (e.g., whether to use the PSCCH 415a associated with the first component carrier, whether to use the PSCCH 415b associated with the second component carrier, or whether to use both the PSCCH 415a associated with the first component carrier and the PSCCH 415b associated with the second component carrier) based at least in part on the indication of the carrier capability received from the Rx/Tx UE 310. In such aspects, the Tx/Rx UE 305 may transmit, to the base station 110, an indication of which control channels will be used for transmitting the control information.

The cross-carrier scheduling aspects described above in connection with example 710 of FIG. 7B may provide efficient use of the radio frequency spectrum and/or enable control signaling on less congested channels, among other benefits. For example, control information (e.g., the indication of the resource reservation sent via the SCI-1 message) does not need to be transmitted on carriers experiencing high interference and/or carriers having congested channels. In that regard, determining which component carrier to use for transmitting the control information, as indicated by reference number 620, may include performing one or more channel congestion measurements and/or receiving one or more channel congestion parameters. For example, the Tx/Rx UE 305 may measure a CBR, a channel occupancy ratio (CR), or a similar channel congestion parameter on one or more component carriers. In such aspects, in the determination indicated by reference number 620, the Tx/Rx UE 305 may determine which component carriers to use for transmitting the control information based at least in part on the channel congestion measurements and/or may provide an indication of the channel congestion measurements to the base station 110 for use by the base station 110 to determine which component carriers to use for transmitting the control information.

Moreover, in some aspects, multiple UEs (e.g., the Tx/Rx UE 305, the Rx/Tx UE 310, and/or other UEs connected to the wireless communication network) may each perform channel congestion measurements on various component carriers (e.g., measurements associated with a CBR, a CR, or the like) and report the measurements to a network controller (e.g., the base station 110 or other controller associated with the core network such as the network controller 130 described in connection with FIGS. 1 and 2), and the network controller may determine which control channels to use for the control information based at least in part on the channel congestion measurements reported from the multiple UEs. More particularly, if, in the aggregate, the channel congestion measurements indicate that the first component carrier is less congested than the second component carrier, the network controller may signal that control information for both component carriers (e.g., the indication of the resource reservation associated with both the first component carrier and the second component carrier) should be transmitted using the first component carrier (e.g., using the PSCCH 415a associated with the first component carrier), as depicted in FIG. 7B. Similarly, the determination of which control channel to use may be based on interference measurements associated with one or more of the component carriers, available bandwidth associated with one or more of the component carriers, or similar considerations. More particularly, the network controller (e.g., the network controller 130), the base station 110, and/or the Tx/Rx UE 305 may determine that that a component carrier having the lowest interference and/or most available bandwidth should be used to carry the control information.

In some aspects, multiple SCI-1 messages may be included in a single control channel (e.g., in the PSCCH 415a associated with the first component carrier), and each SCI-1 message may include a field or other indication indicating a corresponding component carrier associated with the SCI-1 message. For example, in the example depicted in FIG. 7B, two SCI-1 messages may be transmitted in the PSCCH 415a associated with the first component carrier. A first SCI-1 message of the two SCI-1 messages may include an indication of a resource reservation for the first component carrier, and a second SCI-1 message of the two SCI-1 messages may include an indication of a resource reservation for the second component carrier. In such aspects, each SCI-1 may include a set of bits to indicate the corresponding component carrier. In some aspects, the set of bits may include one or more bits of the reserved bits in the SCI-1 message described above in connection with FIG. 4. For example, three bits of the reserved bits of each SCI-1 message may be used to signal the corresponding carrier, which can be used to signal up to eight distinct combinations of bits (e.g., 2³=8) and thus may be used to correspond to eight different component carriers. More particularly, a combination of 000 may indicate that the SCI-1 message corresponds to a first component carrier, a combination of 001 may indicate that the SCI-1 message corresponds to a second component carrier, a combination of 010 may indicate that the SCI-1 message corresponds to a third component carrier, and so forth. In such aspects, the indication of the corresponding component carrier may be transparent to UEs that do not support carrier aggregation, because such UEs may simply ignore the three-bit indication provided in the reserved number of bits of the SCI-1 message. Aspects of the disclosure are not so limited, however, and, in some other aspects, other fields and/or indications may be used to signal the corresponding component carrier. For example, in some aspects, a dedicated field of the SCI-1 message may be used to signal the corresponding carrier. That is, a three-bit carrier aggregation field, a three-bit carrier indication field, or the like may be used to indicate the corresponding component carrier for the SCI-1 messages.

In some aspects, when using cross-carrier scheduling techniques, the control information for multiple carriers may be transmitted in a legacy carrier so that other, nearby UEs receive the reservation information, even when one or more of the other, nearby UEs do not support carrier aggregation and/or are not capable of receiving communications in certain component carriers. In this way, the other, nearby UEs may become aware of the resource reservation on the legacy carrier and thus not attempt to schedule a conflicting or interfering communication using the same resources on the legacy carrier. Returning to the example shown in FIG. 7B, the first component carrier may be a legacy carrier, such that the resource reservations for both the legacy carrier (for purposes of this example, the first component carrier) and the non-legacy carrier (for purposes of this example, the second component carrier) are transmitted in the control channel of the legacy carrier (e.g., using the PSCCH 415a associated with the first component carrier). In that way, other, nearby UEs will be made aware of the resource reservation on the legacy carrier and thus not attempt to schedule conflicting transmissions in the legacy carrier.

Additionally, or alternatively, when a carrier capability of all intended recipients of a transmission is not known by the Tx/Rx UE 305, the control information for multiple carriers may be transmitted in a legacy carrier to ensure all intended UEs receive the control information. For example, if the Tx/Rx UE 305 is operating in a broadcast mode or a connection-less groupcast mode (e.g., groupcast mode 1), the Tx/Rx UE 305 may not know the carrier capability of all receiver UEs and/or may not be able to request information regarding a carrier capability of all receiver UEs. Thus, when implementing cross-carrier scheduling techniques such as those described in connection with FIG. 7B, the control information for multiple component carriers may be transmitted using at least the PSCCH 415 of the legacy carrier (for purposes of this example, the first component carrier), to ensure UEs capable of receiving sidelink communications in both the first component carrier and the second component carrier receive the control information. As described above, this may also beneficially ensure that other, nearby UEs that are not intended recipients of the sidelink communication nonetheless receive the resource reservation information, thereby avoiding potential resource collision by the other, nearby UEs.

In some aspects, one or more network controllers (e.g., the network controller 130, the base station 110, the Tx/Rx UE 305, the Rx/Tx UE 310, or other network component) may signal and/or trigger cross-carrier scheduling, such as the cross-carrier scheduling techniques described above in connection with FIG. 7B. For example, a network controller associated with the core network (e.g., the network controller 130) may trigger cross-carrier scheduling in response to receiving CBR measurements, CR measurements, interference measurements, available bandwidth indications, or similar indications from one or more UEs associated with the network. Thus, in response to the network controller determining that certain component carriers are congested or the like, the network controller may signal to a transmitter the Tx/Rx UE 305 to utilize cross-carrier scheduling and thus transmit control information on less congested carriers. In some aspects, the Tx/Rx UE 305 may itself determine whether to utilize cross-carrier scheduling techniques based on channel congestion measurements, interference measurements, bandwidth availability, or the like, and may signal to other UEs (e.g., the Rx/Tx UE 310) that cross-carrier scheduling should be implemented. For example, for unicast modes, the transmitter UE may configure cross-carrier scheduling using a PC5 RRC message (e.g., an RRC message sent to the Rx/Tx UE 310 using the PC5 interface, or the like). For other cast modes, such as groupcast or broadcast modes, the Tx/Rx UE 305 may dynamically configure whether to use cross-carrier scheduling using a set of the reserved number of bits in the SCI-1 message, and/or using a dedicated field of the SCI-1 message such as the carrier aggregation field and/or the carrier indicator field described above. For example, a carrier indicator field including all zero bits may indicate that cross-carrier scheduling should not be used (e.g., that the SCI-1 message carries scheduling information for the component carrier in which it is sent), while a carrier indicator field including at least one non-zero bit may indicate that cross-carrier scheduling should be used (e.g., that the SCI-1 message carries scheduling information for a different component carrier that the one in which it is sent).

In some aspects, the Tx/Rx UE 305 may determine a carrier capability of the Rx/Tx UE 310 based at least in part on a feedback message received from the Rx/Tx UE 310 (e.g., a message associated with the sidelink feedback 440 received in the PSFCH 425 described in connection with FIG. 4), which, in some aspects, may be a HARQ message. More particularly, in some aspects, all HARQ messages or similar feedback messages may be transmitted within one resource pool, with a format of the HARQ feedback message indicating a carrier capability of the UE transmitting the HARQ feedback message. In some aspects, the resource pool in which HARQ feedback is provided may be a legacy carrier (e.g., the HARQ feedback is provided in a PSFCH 425 associated with the legacy carrier), such that both UEs capable of carrier aggregation or multi-carrier techniques as well as UEs not capable of carrier aggregation or multi-carrier techniques may transmit HARQ messages in the PSFCH 425. In such aspects, a HARQ message provided in a first format (e.g., a legacy format) in the PSFCH 425 indicates that the corresponding UE is capable of only receiving transmissions and/or retransmissions in the first component carrier (e.g., the legacy component carrier), while a HARQ message provided in a second format (e.g., a non-legacy format) in the PSFCH 425 indicates that the corresponding UE is capable of receiving transmissions and/or retransmissions in both the first component carrier and the second component carrier (e.g., in the both the legacy component carrier and the non-legacy component carrier). In this way, the Tx/Rx UE 305 may become aware of one or more receiver UEs' capability by detecting the format of the corresponding HARQ bits transmitted in the PSFCH 425 resource.

Moreover, if the Rx/Tx UE 310 indicates, by providing HARQ feedback in the second format, that the Rx/Tx UE 310 is capable of receiving transmissions and/or retransmissions in both the first component carrier and the second component carrier, then any retransmissions need not be the first component carrier. That is, the Tx/Rx UE 305 may selectively choose which component carrier to use for any retransmissions and may not be limited to transmitting a retransmission within the legacy carrier. Returning to the example shown in FIG. 7B, the Tx/Rx UE 305 may initially transmit control information (e.g., an indication of the resource reservation) for both the first resource pool and the second resource pool using the first component carrier (e.g., the legacy component carrier), and more particularly using the PSCCH 415a associated with the first component carrier. If the Rx/Tx UE 310 then provides HARQ feedback in the first component carrier (and more particularly, within the PSFCH 425 associated with the first component carrier) using a first format (e.g., the legacy format), then any retransmission and/or future transmissions may be transmitted in the first component carrier. However, if the Rx/Tx UE 310 provides HARQ feedback in the first component carrier (and more particularly, within the PSFCH 425 associated with the first component carrier) using a second format (e.g., the non-legacy format), then any retransmission and/or future transmissions may be selectively transmitted in either the first component carrier, in the second component carrier, or in both the first component carrier and the second component carrier. Moreover, when the Tx/Rx UE 305 is transmitting to a group of UEs, such as in a groupcast mode or the like, an initial transmission may be provided in both a first component carrier (e.g., a legacy carrier) and a second component carrier (e.g., a non-legacy carrier), and if the initial transmission to all legacy UEs is successful as determined by the various HARQ messages, then the transmission could optionally be retransmitted using only the second component carrier (e.g., the non-legacy carrier).

In some aspects, the Tx/Rx UE 305 may transmit a transmission (e.g., a TB or the like) over multiple component carriers in order to, for example, improve reliability, achieve load balancing over multiple carriers, or the like. This may be particularly beneficial when the Tx/Rx UE 305 is operating in a broadcast mode or a connection-less groupcast mode and thus a carrier capability of each receiver UE may be unknown to the Tx/Rx UE 305. In some aspects, an SCI message (e.g., an SCI-1 message and/or an SCI-2 message) may indicate that a TB will be transmitted over multiple component carriers. For example, the transmitter UE may transmit a TB across multiple component carriers, sometimes referred to as sweeping across multiple component carriers. In such aspects, an SCI message (e.g., an SCI-1 message and/or an SCI-2 message) may include an indication that the TB will be swept across the multiple component carriers and/or an SCI message may include an indication of a sweeping pattern that will be used to sweep the TB across the multiple component carriers. For example, the SCI-1 message may include one or more bits that indicate that a TB will be duplicated across multiple component carriers (e.g., an indication that the TB will be swept across multiple component carriers). Moreover, the SCI-2 message may include a number of bits indicating a particular transmission pattern (e.g., a sweeping pattern) to be used to sweep the TB across the multiple component carriers. For example, the indication of the particular transmission pattern may indicate which component carriers will be used to transmit the TB and/or a sequence of transmission on each component carrier. In some aspects, various transmission patterns may be provided to each UE (e.g., via high level signaling, network configuration, or the like), with the signaling contained in the SCI messages indicating which one of the various preconfigured transmission patterns will be used to sweep the TB across the multiple component carriers.

As indicated above, FIGS. 7A and 7B are provided as examples. Other examples may differ from what is described with regard to FIGS. 7A and 7B.

FIG. 8 is a diagram illustrating an example process 800 performed, for example, by a UE (e.g., the Tx/Rx UE 305 or another UE described herein), in accordance with the present disclosure. Example process 800 is an example where the UE (e.g., the Tx/Rx UE 305) performs operations associated with multi-carrier scheduling for sidelink communications.

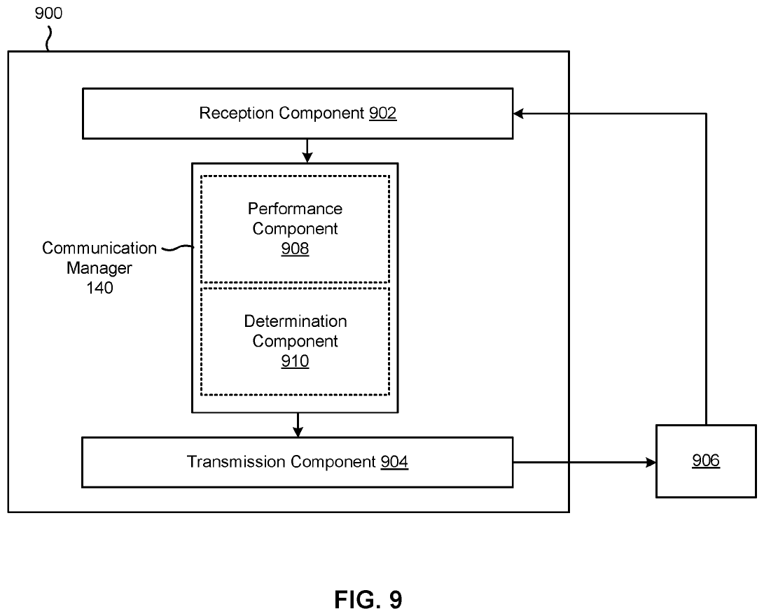

As shown in FIG. 8, in some aspects, process 800 may include receiving a configuration of a first resource pool associated with a first component carrier and a second resource pool associated with a second component carrier (block 810). For example, the UE (e.g., using communication manager 140 and/or reception component 902, depicted in FIG. 9) may receive a configuration of a first resource pool associated with a first component carrier and a second resource pool associated with a second component carrier, as described above.

As further shown in FIG. 8, in some aspects, process 800 may include transmitting an indication of a resource reservation associated with a sidelink communication, wherein the resource reservation indicates a first set of resources associated with the first resource pool and a second set of resources associated with the second resource pool, and wherein the indication of the resource reservation is transmitted in at least one of a first control channel associated with the first component carrier or a second control channel associated with the second component carrier (block 820). For example, the UE (e.g., using communication manager 140 and/or transmission component 904, depicted in FIG. 9) may transmit an indication of a resource reservation associated with a sidelink communication, wherein the resource reservation indicates a first set of resources associated with the first resource pool and a second set of resources associated with the second resource pool, and wherein the indication of the resource reservation is transmitted in at least one of a first control channel associated with the first component carrier or a second control channel associated with the second component carrier, as described above.

As further shown in FIG. 8, in some aspects, process 800 may include performing the sidelink communication in accordance with the resource reservation (block 830). For example, the UE (e.g., using communication manager 140 and/or performance component 908, depicted in FIG. 9) may perform the sidelink communication in accordance with the resource reservation, as described above.

Process 800 may include additional aspects, such as any single aspect or any combination of aspects described below and/or in connection with one or more other processes described elsewhere herein.

In a first aspect, the indication of the resource reservation includes a first message transmitted using the first control channel, the first message indicates the first set of resources associated with the first resource pool, the indication of the resource reservation further includes a second message transmitted using the second control channel, and the second message indicates the second set of resources associated with the second resource pool.

In a second aspect, alone or in combination with the first aspect, the indication of the resource reservation is transmitted to multiple UEs via at least one of a groupcast transmission or a broadcast transmission.

In a third aspect, alone or in combination with one or more of the first and second aspects, the indication of the resource reservation is indicated by one or more messages transmitted using one of the first control channel or the second control channel, and the one or more messages indicate both the first set of resources associated with the first resource pool and the second set of resources associated with the second resource pool.

In a fourth aspect, alone or in combination with one or more of the first through third aspects, process 800 includes determining (e.g., using communication manager 140 and/or determination component 910, depicted in FIG. 9) whether to use the first control channel or the second control channel for transmitting the one or more messages.

In a fifth aspect, alone or in combination with one or more of the first through fourth aspects, determining whether to use the first control channel or the second control channel for transmitting the one or more messages is based at least in part on a first channel congestion parameter associated with the first component carrier and a second channel congestion parameter associated with the second component carrier.

In a sixth aspect, alone or in combination with one or more of the first through fifth aspects, determining whether to use the first control channel or the second control channel for transmitting the one or more messages is based at least in part on at least one of an interference measurement associated with each component carrier or an available bandwidth associated with each component carrier.

In a seventh aspect, alone or in combination with one or more of the first through sixth aspects, process 800 includes receiving (e.g., using communication manager 140 and/or reception component 902, depicted in FIG. 9), from a network entity, an indication of whether to use the first control channel or the second control channel for transmitting the one or more messages.

In an eighth aspect, alone or in combination with one or more of the first through seventh aspects, the indication of whether to use the first control channel or the second control channel for transmitting the one or more messages is based at least in part on multiple channel congestion measurements performed by multiple UEs.

In a ninth aspect, alone or in combination with one or more of the first through eighth aspects, the one or more messages include a first SCI-1 message corresponding to the first component carrier, and a second SCI-1 message corresponding to the second component carrier.

In a tenth aspect, alone or in combination with one or more of the first through ninth aspects, the first SCI-1 message includes an indication that the first SCI-1 message corresponds to the first component carrier using a first set of reserved bits in the first SCI-1 message, and the second SCI-1 message includes an indication that the second SCI-1 message corresponds to the second component carrier using a second set of reserved bits in the second SCI-1 message.

In an eleventh aspect, alone or in combination with one or more of the first through tenth aspects, each of the first set of reserved bits and the second set of reserved bits includes three reserved bits.

In a twelfth aspect, alone or in combination with one or more of the first through eleventh aspects, the first SCI-1 message includes an indication that the first SCI-1 message corresponds to the first component carrier using a first set of bits associated with a carrier indication field of the first SCI-1 message, and the second SCI-1 message includes an indication that the second SCI-1 message corresponds to the second component carrier using a second set of bits associated with a carrier indication field of the second SCI-1 message.

In a thirteenth aspect, alone or in combination with one or more of the first through twelfth aspects, each of the first set of bits and the second set of bits includes three bits.

In a fourteenth aspect, alone or in combination with one or more of the first through thirteenth aspects, a group of UEs are capable of performing sidelink communications using the first component carrier, with less than all of the group of UEs being capable of performing sidelink communications using the second component carrier, and the one or more messages are transmitted using the first control channel.

In a fifteenth aspect, alone or in combination with one or more of the first through fourteenth aspects, process 800 includes receiving (e.g., using communication manager 140 and/or reception component 902, depicted in FIG. 9), from a network entity, a configuration of whether resource reservations associated with the second resource pool may be indicated using the first control channel.

In a sixteenth aspect, alone or in combination with one or more of the first through fifteenth aspects, the configuration of whether resource reservations associated with the second resource pool may be indicated using the first control channel is based at least in part on at least one of a channel congestion measurement, an interference measurement, or a carrier capability determination.

In a seventeenth aspect, alone or in combination with one or more of the first through sixteenth aspects, process 800 includes determining (e.g., using communication manager 140 and/or determination component 910, depicted in FIG. 9) a configuration of whether resource reservations associated with the second resource pool may be indicated using the first control channel, and transmitting (e.g., using communication manager 140 and/or transmission component 904, depicted in FIG. 9), to another UE, the configuration of whether resource reservations associated with the second resource pool may be indicated using the first control channel.

In an eighteenth aspect, alone or in combination with one or more of the first through seventeenth aspects, the sidelink communication is a unicast communication, and the configuration of whether resource reservations associated with the second resource pool may be indicated using the first control channel is transmitted to the other UE using a sidelink RRC message.

In a nineteenth aspect, alone or in combination with one or more of the first through eighteenth aspects, the sidelink communication is one of a groupcast or a broadcast communication, and the configuration of whether resource reservations associated with the second resource pool may be indicated using the first control channel is transmitted to multiple UEs using a first SCI-1 message.

In a twentieth aspect, alone or in combination with one or more of the first through nineteenth aspects, the configuration of whether resource reservations associated with the second resource pool may be indicated using the first control channel is indicated using a set of reserved bits in the first SCI-1 message.

In a twenty-first aspect, alone or in combination with one or more of the first through twentieth aspects, the configuration of whether resource reservations associated with the second resource pool may be indicated using the first control channel is indicated using a set of bits associated with a carrier indication field of the first SCI-1 message.

In a twenty-second aspect, alone or in combination with one or more of the first through twenty-first aspects, process 800 includes receiving (e.g., using communication manager 140 and/or reception component 902, depicted in FIG. 9), from another UE, a HARQ message using the first resource pool, and determining (e.g., using communication manager 140 and/or determination component 910, depicted in FIG. 9) a carrier capability of the other UE based at least in part on a format of the HARQ message.

In a twenty-third aspect, alone or in combination with one or more of the first through twenty-second aspects, the format of the HARQ message indicates that the other UE may receive sidelink communications using only the first component carrier.

In a twenty-fourth aspect, alone or in combination with one or more of the first through twenty-third aspects, the format of the HARQ message indicates that the other UE may receive sidelink communications using both the first component carrier and the second component carrier.

In a twenty-fifth aspect, alone or in combination with one or more of the first through twenty-fourth aspects, process 800 includes retransmitting (e.g., using communication manager 140 and/or transmission component 904, depicted in FIG. 9) the sidelink communication using one or both of the first component carrier and the second component carrier.

In a twenty-sixth aspect, alone or in combination with one or more of the first through twenty-fifth aspects, the sidelink communication is a broadcast communication, and performing the sidelink communication includes transmitting (e.g., using communication manager 140 and/or transmission component 904, depicted in FIG. 9) a duplicated communication using both the first component carrier and the second component carrier.

In a twenty-seventh aspect, alone or in combination with one or more of the first through twenty-sixth aspects, the indication of the resource reservation further indicates that the duplicated communication will be transmitted using both the first component carrier and the second component carrier.

In a twenty-eighth aspect, alone or in combination with one or more of the first through twenty-seventh aspects, process 800 includes receiving (e.g., using communication manager 140 and/or reception component 902, depicted in FIG. 9) the indication of the resource reservation from one of a network entity or another UE.

In a twenty-ninth aspect, alone or in combination with one or more of the first through twenty-eighth aspects, performing the sidelink communication in accordance with the resource reservation includes at least one of transmitting or retransmitting (e.g., using communication manager 140 and/or transmission component 904, depicted in FIG. 9) a communication multiple times, each of the multiple times using a different one of multiple component carriers, according to a pattern of transmission.

In a thirtieth aspect, alone or in combination with one or more of the first through twenty-ninth aspects, the indication of the resource reservation further indicates the pattern of transmission.

In a thirty-first aspect, alone or in combination with one or more of the first through thirtieth aspects, an indication that the communication will be one of transmitted or retransmitted multiple times is indicated using an SCI-1 message, and the pattern of transmission is indicated using an SCI-2 message.

In a thirty-second aspect, alone or in combination with one or more of the first through thirty-first aspects, process 800 includes receiving (e.g., using communication manager 140 and/or reception component 902, depicted in FIG. 9) a configuration of multiple patterns of transmission, with the pattern of transmission being one of the configured multiple patterns of transmission.

In a thirty-third aspect, alone or in combination with one or more of the first through thirty-second aspects, process 800 includes transmitting (e.g., using communication manager 140 and/or transmission component 904, depicted in FIG. 9) the sidelink communication using the first component carrier, and retransmitting (e.g., using communication manager 140 and/or transmission component 904, depicted in FIG. 9) the sidelink communication using both the first component carrier and the second component carrier.

In a thirty-fourth aspect, alone or in combination with one or more of the first through thirty-third aspects, retransmitting the sidelink communication using both the first component carrier and the second component carrier is based at least in part on a first channel congestion measurement associated with the first component carrier and a second channel congestion measurement associated with the second component carrier.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE (e.g., the UE 120, the Tx/Rx UE 305, or another UE described herein), or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UF (e.g., the Rx/Tx UE 310), a base station (e.g., the base station 110), or another wireless communication device) using the reception component 902 and the transmission component 904. As further shown, the apparatus 900 may include the communication manager 140. The communication manager 140 may include one or more of a performance component 908 or a determination component 910, among other examples.

In some aspects, the apparatus 900 may be configured to perform one or more operations described herein in connection with FIG. 6-7. Additionally, or alternatively, the apparatus 900 may be configured to perform one or more processes described herein, such as process 800 of FIG. 8. In some aspects, the apparatus 900 and/or one or more components shown in FIG. 9 may include one or more components of the UE 120 described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE 120 described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE 120 described in connection with FIG. 2. In some aspects, the transmission component 904 may be co-located with the reception component 902 in a transceiver.

The reception component 902 may receive a configuration of a first resource pool associated with a first component carrier and a second resource pool associated with a second component carrier. The transmission component 904 may transmit an indication of a resource reservation associated with a sidelink communication, wherein the resource reservation indicates a first set of resources associated with the first resource pool and a second set of resources associated with the second resource pool, and wherein the indication of the resource reservation is transmitted in at least one of a first control channel associated with the first component carrier or a second control channel associated with the second component carrier. The performance component 908 may perform the sidelink communication in accordance with the resource reservation.

The determination component 910 may determine whether to use the first control channel or the second control channel for transmitting the one or more messages.

The reception component 902 may receive, from a network entity, an indication of whether to use the first control channel or the second control channel for transmitting the one or more messages.

The reception component 902 may receive, from a network entity, a configuration of whether resource reservations associated with the second resource pool may be indicated using the first control channel.

The determination component 910 may determine a configuration of whether resource reservations associated with the second resource pool may be indicated using the first control channel transmitting, to another UE, the configuration of whether resource reservations associated with the second resource pool may be indicated using the first control channel.

The reception component 902 may receive, from another UE, a HARQ message using the first resource pool.

The determination component 910 may determine a carrier capability of the other UE based at least in part on a format of the HARQ message.

The transmission component 904 may retransmit the sidelink communication using one or both of the first component carrier and the second component carrier.

The reception component 902 may receive the indication of the resource reservation from one of a network entity or another UE.

The reception component 902 may receive a configuration of multiple patterns of transmission, wherein the pattern of transmission is one of the configured multiple patterns of transmission.

The transmission component 904 may transmit the sidelink communication using the first component carrier, and retransmit the sidelink communication using both the first component carrier and the second component carrier.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a UE, comprising: receiving a configuration of a first resource pool associated with a first component carrier and a second resource pool associated with a second component carrier; transmitting an indication of a resource reservation associated with a sidelink communication, wherein the resource reservation indicates a first set of resources associated with the first resource pool and a second set of resources associated with the second resource pool, and wherein the indication of the resource reservation is transmitted in at least one of a first control channel associated with the first component carrier or a second control channel associated with the second component carrier; and performing the sidelink communication in accordance with the resource reservation.

Aspect 2: The method of Aspect 1, wherein the indication of the resource reservation includes a first message transmitted using the first control channel, wherein the first message indicates the first set of resources associated with the first resource pool, wherein the indication of the resource reservation further includes a second message transmitted using the second control channel, and wherein the second message indicates the second set of resources associated with the second resource pool.

Aspect 3: The method of Aspect 2, wherein the indication of the resource reservation is transmitted to multiple UEs via at least one of a groupcast transmission or a broadcast transmission.

Aspect 4: The method of any of Aspects 1-3, wherein the indication of the resource reservation is indicated by one or more messages transmitted using one of the first control channel or the second control channel, and wherein the one or more messages indicate both the first set of resources associated with the first resource pool and the second set of resources associated with the second resource pool.

Aspect 5: The method of Aspect 4, further comprising determining whether to use the first control channel or the second control channel for transmitting the one or more messages.

Aspect 6: The method of Aspect 5, wherein determining whether to use the first control channel or the second control channel for transmitting the one or more messages is based at least in part on a first channel congestion parameter associated with the first component carrier and a second channel congestion parameter associated with the second component carrier.

Aspect 7: The method of any of Aspects 5-6, wherein determining whether to use the first control channel or the second control channel for transmitting the one or more messages is based at least in part on at least one of an interference measurement associated with each component carrier or an available bandwidth associated with each component carrier.

Aspect 8: The method of any of Aspects 4-7, further comprising receiving, from a network entity, an indication of whether to use the first control channel or the second control channel for transmitting the one or more messages.

Aspect 9: The method of Aspect 8, wherein the indication of whether to use the first control channel or the second control channel for transmitting the one or more messages is based at least in part on multiple channel congestion measurements performed by multiple UEs.

Aspect 10: The method of any of Aspects 4-9, wherein the one or more messages include a first SCI-1 message corresponding to the first component carrier, and a second SCI-1 message corresponding to the second component carrier.

Aspect 11: The method of Aspect 10, wherein the first SCI-1 message includes an indication that the first SCI-1 message corresponds to the first component carrier using a first set of reserved bits in the first SCI-1 message, and wherein the second SCI-1 message includes an indication that the second SCI-1 message corresponds to the second component carrier using a second set of reserved bits in the second SCI-1 message.

Aspect 12: The method of Aspect 11, wherein each of the first set of reserved bits and the second set of reserved bits includes three reserved bits.

Aspect 13: The method of any of Aspects 10-12, wherein the first SCI-1 message includes an indication that the first SCI-1 message corresponds to the first component carrier using a first set of bits associated with a carrier indication field of the first SCI-1 message, and wherein the second SCI-1 message includes an indication that the second SCI-1 message corresponds to the second component carrier using a second set of bits associated with a carrier indication field of the second SCI-1 message.

Aspect 14: The method of Aspect 13, wherein each of the first set of bits and the second set of bits includes three bits.

Aspect 15: The method of any of Aspects 4-14, wherein a group of UEs are capable of performing sidelink communications using the first component carrier, wherein less than all of the group of UEs are capable of performing sidelink communications using the second component carrier, and wherein the one or more messages are transmitted using the first control channel.

Aspect 16: The method of any of Aspects 1-15, further comprising receiving, from a network entity, a configuration of whether resource reservations associated with the second resource pool may be indicated using the first control channel.

Aspect 17: The method of Aspect 16, wherein the configuration of whether resource reservations associated with the second resource pool may be indicated using the first control channel is based at least in part on at least one of a channel congestion measurement, an interference measurement, or a carrier capability determination.

Aspect 18: The method of any of Aspects 1-17, further comprising determining a configuration of whether resource reservations associated with the second resource pool may be indicated using the first control channel; and transmitting, to another UE, the configuration of whether resource reservations associated with the second resource pool may be indicated using the first control channel.

Aspect 19: The method of Aspect 18, wherein the sidelink communication is a unicast communication, and wherein the configuration of whether resource reservations associated with the second resource pool may be indicated using the first control channel is transmitted to the other UE using a sidelink RRC message.

Aspect 20: The method of any of Aspects 18-19, wherein the sidelink communication is one of a groupcast or a broadcast communication, and wherein the configuration of whether resource reservations associated with the second resource pool may be indicated using the first control channel is transmitted to multiple UEs using a first SCI-1 message.

Aspect 21: The method of Aspect 20, wherein the configuration of whether resource reservations associated with the second resource pool may be indicated using the first control channel is indicated using a set of reserved bits in the first SCI-1 message.

Aspect 22: The method of any of Aspects 20-21, wherein the configuration of whether resource reservations associated with the second resource pool may be indicated using the first control channel is indicated using a set of bits associated with a carrier indication field of the first SCI-1 message.

Aspect 23: The method of any of Aspects 1-22, further comprising: receiving, from another UE, a HARQ message using the first resource pool; and determining a carrier capability of the other UE based at least in part on a format of the HARQ message.

Aspect 24: The method of Aspect 23, wherein the format of the HARQ message indicates that the other UE may receive sidelink communications using only the first component carrier.

Aspect 25: The method of Aspect 23, wherein the format of the HARQ message indicates that the other UE may receive sidelink communications using both the first component carrier and the second component carrier.

Aspect 26: The method of Aspect 25, further comprising retransmitting the sidelink communication using one or both of the first component carrier and the second component carrier.

Aspect 27: The method of any of Aspects 1-26, wherein the sidelink communication is a broadcast communication, and wherein performing the sidelink communication includes transmitting a duplicated communication using both the first component carrier and the second component carrier.

Aspect 28: The method of Aspect 27, wherein the indication of the resource reservation further indicates that the duplicated communication will be transmitted using both the first component carrier and the second component carrier.

Aspect 29: The method of any of Aspects 1-28, further comprising receiving the indication of the resource reservation from one of a network entity or another UE.

Aspect 30: The method of any of Aspects 1-29, wherein performing the sidelink communication in accordance with the resource reservation includes at least one of transmitting or retransmitting a communication multiple times, each of the multiple times using a different one of multiple component carriers, according to a pattern of transmission.

Aspect 31: The method of Aspect 30, wherein the indication of the resource reservation further indicates the pattern of transmission.

Aspect 32: The method of Aspect 31, wherein an indication that the communication will be one of transmitted or retransmitted multiple times is indicated using an SCI-1 message, and wherein the pattern of transmission is indicated using an SCI-2 message.

Aspect 33: The method of Aspect 32, further comprising receiving a configuration of multiple patterns of transmission, wherein the pattern of transmission is one of the configured multiple patterns of transmission.

Aspect 34: The method of any of Aspects 1-33, further comprising transmitting the sidelink communication using the first component carrier, and retransmitting the sidelink communication using both the first component carrier and the second component carrier.

Aspect 35: The method of Aspect 34, wherein retransmitting the sidelink communication using both the first component carrier and the second component carrier is based at least in part on a first channel congestion measurement associated with the first component carrier and a second channel congestion measurement associated with the second component carrier.

Aspect 36: An apparatus for wireless communication at a device, comprising a processor; memory coupled with the processor; and instructions stored in the memory and executable by the processor to cause the apparatus to perform the method of one or more of Aspects 1-35.

Aspect 37: A device for wireless communication, comprising a memory and one or more processors coupled to the memory, the one or more processors configured to perform the method of one or more of Aspects 1-35.

Aspect 38: An apparatus for wireless communication, comprising at least one means for performing the method of one or more of Aspects 1-35.

Aspect 39: A non-transitory computer-readable medium storing code for wireless communication, the code comprising instructions executable by a processor to perform the method of one or more of Aspects 1-35.

Aspect 40: A non-transitory computer-readable medium storing a set of instructions for wireless communication, the set of instructions comprising one or more instructions that, when executed by one or more processors of a device, cause the device to perform the method of one or more of Aspects 1-35.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive a configuration of a first resource pool associated with a first component carrier and a second resource pool associated with a second component carrier;
transmit an indication of a resource reservation associated with a sidelink communication, wherein the resource reservation indicates a first set of resources associated with the first resource pool and a second set of resources associated with the second resource pool, and wherein the indication of the resource reservation is transmitted in at least one of a first control channel associated with the first component carrier or a second control channel associated with the second component carrier; and
perform the sidelink communication in accordance with the resource reservation.

2. The apparatus of claim 1, wherein the indication of the resource reservation includes a first message transmitted using the first control channel, wherein the first message indicates the first set of resources associated with the first resource pool, wherein the indication of the resource reservation further includes a second message transmitted using the second control channel, and wherein the second message indicates the second set of resources associated with the second resource pool.

3. The apparatus of claim 2, wherein the indication of the resource reservation is transmitted to multiple UEs via at least one of a groupcast transmission or a broadcast transmission.

4. The apparatus of claim 1, wherein the indication of the resource reservation is indicated by one or more messages transmitted using one of the first control channel or the second control channel, and wherein the one or more messages indicate both the first set of resources associated with the first resource pool and the second set of resources associated with the second resource pool.

5. The apparatus of claim 4, wherein the one or more processors are further configured to determine whether to use the first control channel or the second control channel for transmitting the one or more messages.

6. The apparatus of claim 5, wherein determining whether to use the first control channel or the second control channel for transmitting the one or more messages is based at least in part on a first channel congestion parameter associated with the first component carrier and a second channel congestion parameter associated with the second component carrier.

7. The apparatus of claim 5, wherein determining whether to use the first control channel or the second control channel for transmitting the one or more messages is based at least in part on at least one of an interference measurement associated with each component carrier or an available bandwidth associated with each component carrier.

8. The apparatus of claim 4, wherein the one or more processors are further configured to receive, from a network entity, an indication of whether to use the first control channel or the second control channel for transmitting the one or more messages.

9. The apparatus of claim 8, wherein the indication of whether to use the first control channel or the second control channel for transmitting the one or more messages is based at least in part on multiple channel congestion measurements performed by multiple UEs.

10. The apparatus of claim 4, wherein the one or more messages include a first first-stage sidelink control information (SCI-1) message corresponding to the first component carrier, and a second SCI-1 message corresponding to the second component carrier.

11. The apparatus of claim 10, wherein the first SCI-1 message includes an indication that the first SCI-1 message corresponds to the first component carrier using a first set of reserved bits in the first SCI-1 message, and wherein the second SCI-1 message includes an indication that the second SCI-1 message corresponds to the second component carrier using a second set of reserved bits in the second SCI-1 message.

12. The apparatus of claim 10, wherein the first SCI-1 message includes an indication that the first SCI-1 message corresponds to the first component carrier using a first set of bits associated with a carrier indication field of the first SCI-1 message, and wherein the second SCI-1 message includes an indication that the second SCI-1 message corresponds to the second component carrier using a second set of bits associated with a carrier indication field of the second SCI-1 message.

13. The apparatus of claim 1, wherein the one or more processors are further configured to receive, from a network entity, a configuration of whether resource reservations associated with the second resource pool may be indicated using the first control channel.

14. The apparatus of claim 13, wherein the configuration of whether resource reservations associated with the second resource pool may be indicated using the first control channel is based at least in part on at least one of a channel congestion measurement, an interference measurement, or a carrier capability determination.

15. The apparatus of claim 1, wherein the one or more processors are further configured to:
determine a configuration of whether resource reservations associated with the second resource pool may be indicated using the first control channel; and
transmit, to another UE, the configuration of whether resource reservations associated with the second resource pool may be indicated using the first control channel.

16. The apparatus of claim 1, wherein the one or more processors are further configured to:
receive, from another UE, a hybrid automatic repeat transmission (HARQ) message using the first resource pool; and
determine a carrier capability of the other UE based at least in part on a format of the HARQ message.

17. The apparatus of claim 16, wherein the format of the HARQ message indicates that the other UE may receive sidelink communications using only the first component carrier.

18. The apparatus of claim 16, wherein the format of the HARQ message indicates that the other UE may receive sidelink communications using both the first component carrier and the second component carrier.

19. The apparatus of claim 18, wherein the one or more processors are further configured to retransmit the sidelink communication using one or both of the first component carrier and the second component carrier.

20. The apparatus of claim 1, wherein the one or more processors are further configured to receive the indication of the resource reservation from one of a network entity or another UE.

21. The apparatus of claim 1, wherein the one or more processors are further configured to at least one of transmit or retransmit a communication multiple times, each of the multiple times using a different one of multiple component carriers, according to a pattern of transmission.

22. The apparatus of claim 21, wherein the indication of the resource reservation further indicates the pattern of transmission.

23. The apparatus of claim 22, wherein an indication that the communication will be one of transmitted or retransmitted multiple times is indicated using a first-stage sidelink control information (SCI-1) message, and wherein the pattern of transmission is indicated using a second-stage sidelink control information (SCI-2) message.

24. The apparatus of claim 1, wherein the one or more processors are further configured to transmit the sidelink communication using the first component carrier, and retransmit the sidelink communication using both the first component carrier and the second component carrier.

25. A method of wireless communication performed by a user equipment (UE), comprising:
receiving a configuration of a first resource pool associated with a first component carrier and a second resource pool associated with a second component carrier;
transmitting an indication of a resource reservation associated with a sidelink communication, wherein the resource reservation indicates a first set of resources associated with the first resource pool and a second set of resources associated with the second resource pool, and wherein the indication of the resource reservation is transmitted in at least one of a first control channel associated with the first component carrier or a second control channel associated with the second component carrier; and
performing the sidelink communication in accordance with the resource reservation.

26. The method of claim 25, wherein the indication of the resource reservation is indicated by one or more messages transmitted using one of the first control channel or the second control channel, and wherein the one or more messages indicate both the first set of resources associated with the first resource pool and the second set of resources associated with the second resource pool.

27. A non-transitory computer-readable medium storing a set of instructions for wireless communication, the set of instructions comprising:
one or more instructions that, when executed by one or more processors of a user equipment (UE), cause the UE to:
receive a configuration of a first resource pool associated with a first component carrier and a second resource pool associated with a second component carrier;
transmit an indication of a resource reservation associated with a sidelink communication, wherein the resource reservation indicates a first set of resources associated with the first resource pool and a second set of resources associated with the second resource pool, and wherein the indication of the resource reservation is transmitted in at least one of a first control channel associated with the first component carrier or a second control channel associated with the second component carrier; and
perform the sidelink communication in accordance with the resource reservation.

28. The non-transitory computer-readable medium of claim 27, wherein the indication of the resource reservation includes a first message transmitted using the first control channel, wherein the first message indicates the first set of resources associated with the first resource pool, wherein the indication of the resource reservation further includes a second message transmitted using the second control channel, and wherein the second message indicates the second set of resources associated with the second resource pool.

29. An apparatus for wireless communication, comprising:
means for receiving a configuration of a first resource pool associated with a first component carrier and a second resource pool associated with a second component carrier;
means for transmitting an indication of a resource reservation associated with a sidelink communication, wherein the resource reservation indicates a first set of resources associated with the first resource pool and a second set of resources associated with the second resource pool, and wherein the indication of the resource reservation is transmitted in at least one of a first control channel associated with the first component carrier or a second control channel associated with the second component carrier; and
means for performing the sidelink communication in accordance with the resource reservation.

30. The apparatus of claim 29, wherein the indication of the resource reservation is indicated by one or more messages transmitted using one of the first control channel or the second control channel, and wherein the one or more messages indicate both the first set of resources associated with the first resource pool and the second set of resources associated with the second resource pool.
